(19) United States
(12) Patent Application Publication
(10) Pub. No.: US 2025/0241483 A1
(43) Pub. Date: Jul. 31, 2025

(54) Rotating Grill with a Thermoelectric Generator

(71) Applicant: Schwenker USA LLC, Pinckney, MI (US)

(72) Inventors: Roy Farmer, Pinckney, MI (US); Aaron Vermeulen, Pinckney, MI (US)

(21) Appl. No.: 19/013,255

(22) Filed: Jan. 8, 2025

Related U.S. Application Data
(60) Provisional application No. 63/626,640, filed on Jan. 30, 2024.

(51) Int. Cl. A47J 37/04; A47J 37/07

(52) U.S. Cl. CPC A47J 37/043; A47J 37/049; A47J 37/0713; A47J 37/0786

(57) ABSTRACT

A grill comprising that includes a body defining an interior cavity, a grilling surface disposed in the interior cavity, and a motor. The motor is coupled to the grilling surface and configured to rotate the grilling surface with respect to the body such that the grilling surface remains within the interior cavity of the body during rotation.

### CROSS-REFERENCE TO RELATED APPLICATION

This application claims the benefit of U.S. Provisional Application Ser. No. 63/626,640 filed on Jan. 30, 2024, which is incorporated herein in its entirety by reference.

### TECHNICAL FIELD

This disclosure relates to a grill, and more specifically, to a grill that includes a rotating grilling surface powered by a thermoelectric generator.

### BACKGROUND

Conventional grills may typically include a grilling surface (e.g., a grate) located within a body of the grill. One or more burners may generate heat via an external power source, such as gas and/or electricity, to cook various food items located on the grilling surface. Typically, the grilling surface remains stationary such that the food items may be moved (e.g., rotated and/or repositioned) along the grilling surface to ensure even cooking. Such movement may be done manually by a user of the grill.

### SUMMARY

In one aspect of the present disclosure, a grill is disclosed. The grill includes a body defining an interior cavity, a grilling surface disposed in the interior cavity, and a motor. The motor is coupled to the grilling surface and configured to rotate the grilling surface with respect to the body such that the grilling surface remains within the interior cavity of the body during rotation.

In some configurations, the motor may be positioned external to the body and may be coupled to the grilling surface by a rod extending therebetween. The rod may define an axis of rotation of the grilling surface. The motor may include a spindle configured to rotate about the axis of rotation of the grilling surface. The spindle may be configured to couple to the rod.

In some configurations, the rod may be releasably coupled to the grilling surface by a keying mechanism. The keying mechanism may include a male portion coupled to the grilling surface and a female portion defined by the rod. The female portion may be configured to receive the male portion to releasably couple the grilling surface to the rod.

In some configurations, the grilling surface may be circular in shape.

In some configurations, the grill may also include a burned disposed in the interior cavity of the body and positioned adjacent to the grilling surface. The grill may further include a thermoelectric device that is configured to convert heat energy expelled by the burner into electrical energy to power the motor. The thermoelectric device may be located external to the body and may be coupled to an exterior portion of the body. The thermoelectric device may be located within the interior cavity of the body. The thermoelectric device may be located between an upper mounting plate and a lower mounting plate. One or more cooling fins may be coupled to, and may extend from, the lower mounting plate. The motor may be located between the one or more cooling fins.

In another aspect of the present disclosure, a grill is disclosed. The grill includes a body defining an interior cavity, a grilling surface disposed in the interior cavity and configured to rotate about an axis of rotation, a burner configured to generate heat within the interior cavity of the body, a motor, a rod coupled to the motor and coupled to the grilling surface, and a thermoelectric device. The motor is configured to rotate the rod such that the rod turn rotates the grilling surface about the axis of rotation. The thermoelectric device is configured to power the motor based upon conversion of the heat generated by the burner into electrical energy.

In some configurations, the thermoelectric device may be connected to the motor via wiring to transfer the electrical energy to the motor.

In some configurations, the thermoelectric device may be located external to the body.

In some configurations, the thermoelectric device may be disposed on a support plate. The support plate may be located between an upper mounting plate and a lower mounting plate.

In some configurations, the grilling surface, the rod, and the motor may be coaxial along the axis of rotation of the grilling surface.

In another aspect of the present disclosure, an oven is disclosed. The oven includes a body defining an interior cavity, a cooking surface located within the interior cavity, a motor coupled to the cooking surface, and a thermoelectric device located within the interior cavity. The body includes a door which permits access to the interior cavity. The motor is configured to rotate the cooking surface about an axis of rotation. The thermoelectric device is configured to power the motor.

In some configurations, the thermoelectric device may be located above the cooking surface in an elevational direction of the oven. The door may permit access through an opening of the body and the cooking surface may be aligned with a bottom of the opening with respect to the elevational direction.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a front view of grill in accordance with the present teachings.

FIG. 1B is cross-section 1B of the grill of FIG. 1A.

FIG. 1C is another example of a cross-section of the grill of FIG. 1A illustrating an alternative shape of a grill body and a grilling surface.

FIG. 2A is a front view of a portion of the grill of FIG. 2A.

FIG. 2B is cross-section 2B of the portion of the grill of FIG. 2B.

FIG. 3 is a perspective view of a thermoelectric generator of the grill of FIG. 1A.

FIG. 4 is a front view of an oven in accordance with the present teachings.

FIG. 5 is a top-down view of a portion of the oven shown in FIG. 4 illustrating an example of an oven body and a cooking surface.

### DETAILED DESCRIPTION

The present disclosure relates to a grill. The grill may be configured to cook one or more food items. The grill may include, or may be connected to, a power source to generate heat to cook the food. For example, the grill may be electrically connected (e.g., to a power outlet of a home or vehicle) to electrically generate heat. Alternatively, the grill may generate heat in another matter, such as using propane, natural gas, wood, charcoal, or a combination thereof. To facilitate cooking of food, the grill may include a grilling surface, such as a grate, that may be positioned adjacent to a heat source of the grill, such as one or more burners of the grill. The grilling surface may move (e.g., rotate) with respect to the heat source to promote more evenly cooked food.

Conventional grills may often include a stationary grilling surface (e.g., grate) that is positioned within a body of the grill. The grilling surface may be positioned adjacent to and above a heat source, such as one or more burners generating a flame. As a result, the food remains stationary during cooking unless a user manually moves the food. Similarly, if the food remains stationary during cooking, a portion of the food may directly face the flame generated by the one or more burners while another portion of the food may be indirectly cooked by an overall temperature within the body of the grill. As a result, the food may unevenly cook and/or burn without user interaction throughout the cooking process.

The present teachings provide embodiments of a grill which address the aforementioned challenges as described in further detail below. The grill as described herein may advantageously provide a means for evenly cooking food. Additionally, the grill embodiments described herein may facilitate more automated cooking of food without requiring user interaction throughout the cooking process. As a result, the grill embodiments herein may provide an improved means for cooking food by decreasing the risk of overcooking and/or uneven cooking, thereby decreasing overall food waste.

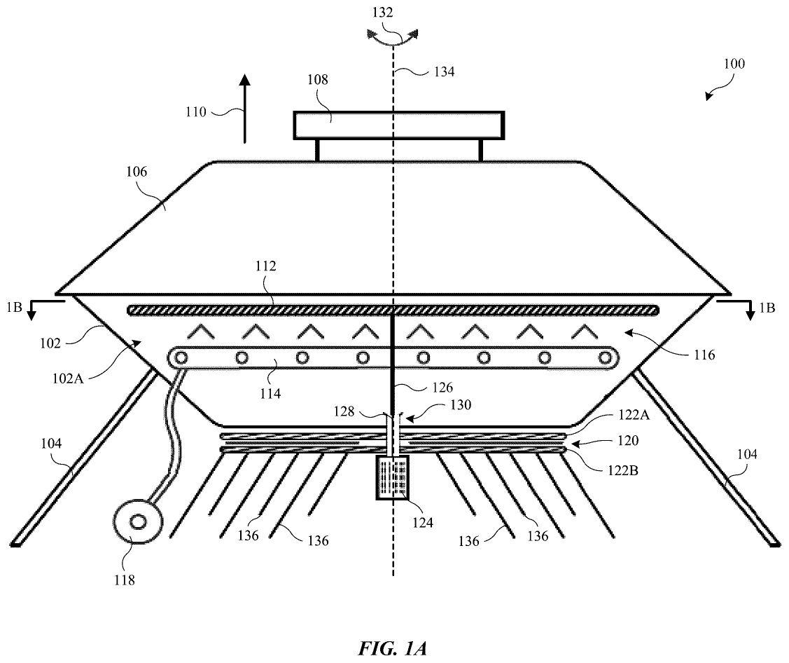

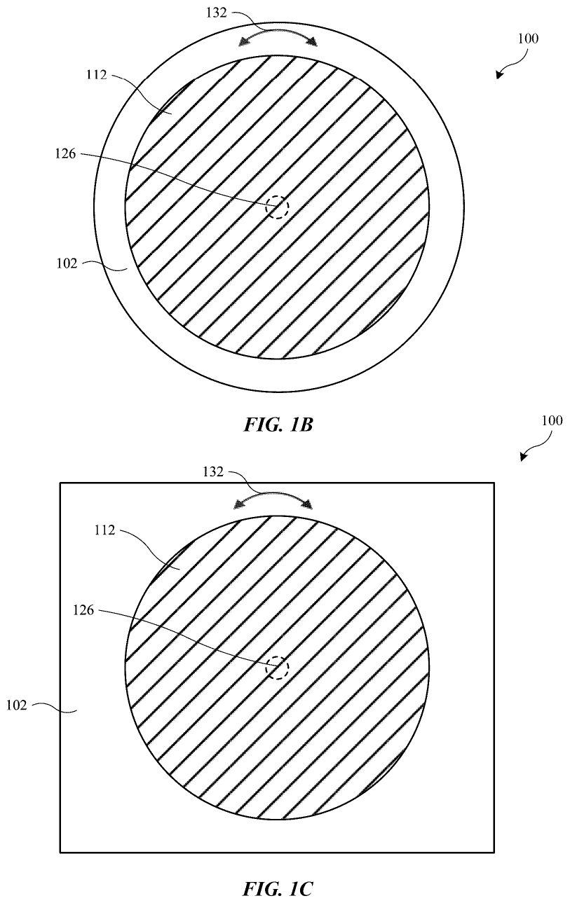

Turning now to the figures, FIG. 1A illustrates a front view of a grill 100 in accordance with the present teachings.

The grill 100 may include a body 102 that defines an interior cavity 102A. That is, the body 102 may at least partially form an interior compartment of the grill 100, which may include the interior cavity 102A. Such an interior compartment may be configured to retain heat to cook one or more food items within the interior compartment, as discussed further below. As such, the body 102 of the grill 100 may vary in size and/or shape to adjust the overall dimensions of the interior cavity 102A. For example, the body 102 may be contain one or more tapered portions (e.g., walls) such that an overall shape of the interior cavity 102A converges at a bottom portion and/or a top portion of the interior cavity 102A. It should be noted, however, that the body 102 and the interior cavity 102A are not limited to any particular shape.

The body 102 may be supported by one or more legs 104. The legs 104 may be coupled to the body 102 or otherwise supportive of the body 102. However, it should be noted that the body 102 may also be free of the legs 104. For example, the body 102 may be freestanding or be configured to be integrated into a countertop (i.e., a “drop-in” grill). As such, the grill 100 is not particularly limited to any configuration and/or geometry of the legs 104.

As discussed above, the body 102 may at least partially form an interior compartment of the grill 100, which may contain one or more food items for cooking. Such an interior compartment may be formed at least partially by the interior cavity 102A defined by the body 102. The interior compartment may also be at least partially formed and/or enclosed by a lid 106 of the grill 100. For example, as shown in FIG. 1A, the lid 106 may be disposed over the body 102 to enclose the interior cavity 102A such that heat generated within the interior cavity 102A remains substantially enclosed within the interior cavity 102A.

The lid 106 may also be shaped to define an interior portion therein that may increase a size of the interior compartment of the grill 100. That is, an interior portion of the lid 106 in combination with the interior cavity 102A of the body 102 may define an overall interior compartment of the grill 100. It should be noted that in certain configurations the lid 106 may be substantially solid or otherwise not define a hollow interior portion such that the lid 106 may enclose the interior cavity 102A of the body 102 and the interior cavity 102A may make up an entirety of the interior compartment of the grill 100.

To facilitate access to the interior cavity 102A of the body 102, the lid 106 may include a handle 108. The handle 108 may be any projection, knob, attachment, lip, bracket, other structural features of the lid 106, or a combination thereof. For example, the handle 108 may be an attachment coupled to an exterior surface of the lid 106, whereby a user may grasp the handle 108 and move the lid 106 in a direction 110 away from the body 102 to permit access to the interior cavity 102A of the body 102.

As discussed further below, certain configurations of the grill 100 may be free of the lid 106 and/or the handle 108. For example, the body 102 may include an access panel (e.g., a door) that may be movably coupled to the body 102 and configured to open to permit access to the interior cavity 102A. Alternatively, the lid 106 may be coupled to the body 102 by a hinge such that the lid 106 may be movably coupled to the body 102 and configured to swing away from the body 102, thereby not necessarily requiring the handle 108.

Access to the interior cavity 102A may permit the user to access a grilling surface 112 located therein. The grilling surface 112 may be disposed at least partially within the body 102 (i.e., within the interior cavity 102A defined by the body 102) and configured to support the food items. That is, the grilling surface 112 may support the food items during cooking of the food items within the grill 100. For example, the user may move the lid 106 in the direction 110 to access the grilling surface 112 and place the food items on the grilling surface 112, at which point the user may then reposition the lid 106 to enclose the interior cavity 102A and enclose the food items therein for cooking.

The grilling surface 112 may be any material (e.g., stainless steel, cast iron, ceramic, etc.) and/or configuration. For example, the grilling surface 112 may be a substantially planar surface, may be a substantially continuous surface, or both. The grilling surface 112 may define one or more holes or openings therein. For example, the grilling surface 112 may be one or more grates that may generally form an interconnected mesh-like structure to support the food items.

Additionally, the grilling surface 112 may include one or more undulations and/or contours. Moreover, as discussed further below, the grilling surface 112 is not particularly limited to any shape. For example, the grilling surface 112 may be generally circular, rectangular, square, triangular, oval, the like, or a combination thereof.

The grilling surface 112 may be located within the interior cavity 102A and positioned adjacent to a burner 114 of the grill 100. As shown in FIG. 1A, the burner 114 may be disposed in the interior cavity 102A of the body 102 such that the grilling surface 112 is located adjacent to, and directly above, the burner 114. Such positioning of the burner 114 relative to the grilling surface 112 may vary and/or may be adjustable.

The burner 114 may be configured to generate and regulate heat 116 within the interior cavity 402A of the grill 100. For example, the burner 114 may generate one or more flames to generate the heat 116 and cook the food items disposed on the grilling surface 112. To generate the heat 116, the burner 114 may be connected to a gas supply, such as propane or natural gas, via a hose 118. Gas may be supplied to the burner 114 through the hose 118 and ignited (e.g., via an ignition system of the grill 100) to generate the flames and thus the heat 116 within the interior cavity 102A of the body 102. The burner 114 may also be configured to regulated or otherwise control the heat 116, such as by adjusting a size of the flames generated, thereby allowing a user to regulate a temperature within the grill 100 to cook the food items.

It should also be noted that, while a single burner (e.g., the burner 114) is described above, the grill 100 may include one or more burners. That is, the grill 100 may include a plurality of the burner 114, whereby the burners may be interconnected to generate additional flames and/or the heat 116. Similarly, the burner 114 may include any configuration that may facilitate generation of the heat 116, such as an open-flame burner, an infrared burner, a tube burner, or a combination thereof. Moreover, while a gas supply is described above, the burner 114 may generate the heat 116 using other sources, such as electricity.

The grilling surface 112 may also be configured to rotate with respect to the body 102. Such rotation of the grilling surface 112 may advantageously allow for more evenly cooked food items, whereby the food items may continuous or incrementally move within the interior cavity 102A to ensure that various portions of the food items are exposed to the heat 116 in different positions.

To facilitate rotation of the grilling surface 112, the grill 100 may include or be connected to a power source. For example, the grill 100 may be connected to an electrical outlet of a house or vehicle. However, to grill 100 may also include a self-contained power source, such as a thermoelectric device 120. As a result, the grill 100 may not require any external power cords and/or wiring to power rotation of the grilling surface 112 and/or other electrical items within the grill 100 (e.g., lights, speakers, rotisserie mechanisms, etc.).

To create the self-contained power source, the thermoelectric device 120 may be configured to convert heat energy expelled by the burner 114 into electrical energy. That is, the thermoelectric device 120 may absorb or otherwise receive the heat 116 (i.e., the heat energy) generated by the burner 114 and convert the heat 116 into electrical energy that may be fed to one or more electrical items of the grill 100 to power the one or more electrical items. For example, the thermoelectric device 120 may be configured to convert the heat 116 (.e., the heat energy) expelled by the burner 114 to power a motor 124 of the grill 100.

The thermoelectric device 120 may be positioned within or adjacent to the interior cavity 102A of the body 102 so that the thermoelectric device 120 may be exposed to the heat 116 generated by the burner 114. The thermoelectric device 120 may be located within the interior cavity 102A of the body 102. Alternatively, or additionally, the thermoelectric device 120 may be located external to the body 102 and coupled to an exterior portion of the body 102. By way of example, as shown in FIG. 1A, the thermoelectric device 120 may be located between an upper mounting plate 122A and a lower mounting plate 122B, whereby the upper mounting plate 122A may be coupled to, or otherwise mounted adjacent to, an exterior surface of the body 102. As such, the thermoelectric device 120 may be positioned anywhere within or external to the body 102 such that the thermoelectric device 120 may be exposed to the heat 116 generated by the burner 114.

It should be noted that any type of thermoelectric device may be utilized in the grill 100 that may generate electricity. That is, the thermoelectric device 120 may be any thermoelectric generator (TEG) or thermoelectric module. In certain configurations, the thermoelectric device 120 may also include a thermoelectric cooler (TEC) to facilitate cooling of the interior cavity 102A to rapidly decrease a temperature therein once cooking is completed. For example, the thermoelectric device 120 may be a thermoelectric module that contains both a TEG and a TEC to provide further versatility to operation of the grill 100.

As mentioned above, the thermoelectric device 120 may be configured to power the motor 124 of the grill 100. The motor 124 may be coupled to the grilling surface 112 and configured to rotate the grilling surface 112 (e.g., based upon electrical power generated by the thermoelectric device 120 and provided to the motor 124) with respect to the body 102 such that the grilling surface 112 remains within the interior cavity 102A of the body 102 during rotation.

By way of example, the motor 124 may be coupled to the grilling surface 112 by a rod 126 extending therebetween. The motor 124 may include a spindle 128 that may be coupled to the rod 126, whereby the spindle 128 may rotate the rod 126 to in turn rotate the grilling surface 112. For example, the motor 124 may be located external to the body 102 such that the spindle 128 may extend through an opening 130 of the body 102 to be coupled to the rod 126 and rotate the rod 126. In particular, the heat 116 generated by the burner 114 may be converted into electricity (i.e., electrical power) by the thermoelectric device 120, whereby the electricity may be transferred to the motor 124 to rotate the spindle 128, the rod 126, and the grilling surface 112. Therefore, the thermoelectric device 120 in communication with the motor 124 may facilitate rotation of the grilling surface 112.

Based on the above configuration, the grilling surface 112 may be disposed in the interior cavity 102A of the body 102 and configured to rotate in a direction 132 about an axis of rotation 134. The axis of rotation 134 may be an elevational axis of the grill 100. The rod 126 may at least partially define the axis of rotation 134 of the grilling surface 112 or may be located along the axis of rotation 134. Similarly, the spindle 128 of the motor 124 may at least partially define the axis of rotation 134 of the grilling surface 112 or may be located along the axis of rotation 134. That is, the spindle 128 may be configured to rotate about the axis of rotation 134 of the grilling surface 112.

Thus, the motor 124 (e.g., the spindle 128 of the motor 124) may be configured to rotate the rod 126 about the axis of rotation 134 of the grilling surface 112 such that the rod 126 in turn rotates the grilling surface 112 about the axis of rotation 134 of the grilling surface 112. To facilitate such movement, the grilling surface 112, the rod 126, and the motor 124 or a portion of the motor 124 (e.g., the spindle 128) may be coaxial along the axis of rotation 134 of the grilling surface 112.

Based on the above, the grill 100 may be substantially self-contained and configured to operate independent of an external power source. For example, in a configuration where the hose 118 is connected to a propane tank for gas supply, the grill 100 may be operated in any desired located free of additional external power and/or gas connections. As a result, rotation of the grilling surface 112 may be operated by the components within the grill 100 based only on a supply of gas.

It should be noted that positioning of the components described above may vary based upon a configuration of the grill 100. For example, the motor 124 may be positioned internally within the interior cavity 102A of the body 102 or external to the body 102 to protect the motor 124 from the heat 116.

Similarly, the grill 100 may include one or more heat dissipating and/or heat deflecting mechanisms to protect one or more components of the grill 100, such as the thermoelectric device 120 and/or the motor 124, from direct exposure to critical temperatures within the grill 100 (e.g., direct exposure to a flame of the burner 114). The grill 100 may include one or more chimneys, one or more vents, one or more fans, other cooling mechanisms, or a combination thereof.

By way of example, the grill 100 may include one or more cooling fins 136 that may be coupled to, and extend from, the lower mounting plate 122B. In such a case, the cooling fins 136 may be configured to cool a region surrounding the motor 124 and/or another portion of the grill 100. For example, the motor may be located between the one or more cooling fins 136 such that the cooling fins 136 may decrease a localized temperature around the motor 124 to protect the motor 124 from overheating. However, the cooling fins 136 may also be positioned anywhere along the grill 100 within or external to the interior cavity 102A. Similarly, the cooling fins 136 may extend in any direction and/or may be formed with any desired geometry.

FIG. 1B illustrates cross-section 1B of the grill 100 of FIG. 1A. As discussed above, the grilling surface 112 may be configured to rotate in the direction 132 about the axis of rotation 134 of grilling surface 112. The rod 126 may be coupled to the motor 124 (e.g., the spindle 128 of the motor 124) and may be coupled to the grilling surface 112 to facilitate rotation of the grilling surface 112 in the direction 132. During rotation of the grilling surface 112, the grilling surface 112 may remain within the interior cavity 102A and the body 102 of the grill 100 may remain stationary. While rotation of the grilling surface 112 in the direction 132 has been discussed herein based on actuation by the motor 124, rotation of the grilling surface 112 may also be done manually in certain configurations, such as using a handle or projection coupled to the grilling surface 112.

Additionally, as mentioned above, the grilling surface 112 and the body 102 may be any desired size and/or shape. For example, as shown in FIG. 1B, the grilling surface 112 may be circular and the body 102 may also be circular, whereby the grilling surface 112 and the body 102 may be substantially coaxial (e.g., coaxial about the axis of rotation 134 of the grilling surface 112). The grilling surface 112 as shown in FIG. 1B may also be a grate that includes one or more interconnected bars or rods such that the grate may define a plurality of openings extending through the grilling surface 112 to better expose food items to the heat 116 generated by the burner 114.

The grilling surface 112 and the body 102 are not limited to a circular shape. For example, in another example of a cross-section of the grill 100 shown in FIG. 1C, the grilling surface 112 may be circular and the body 102 of the grill 100 may be rectangular or square. The grilling surface 112 may still be configured to rotate in the direction 132 based upon rotation of the rod 126 while the body 102 remains stationary. As such, the interior cavity 102A of the body 102 may still at least partially contain the grilling surface 112 and allow for rotation of the grilling surface 112 even if the body 102 is not similar in shape to the grilling surface 112.

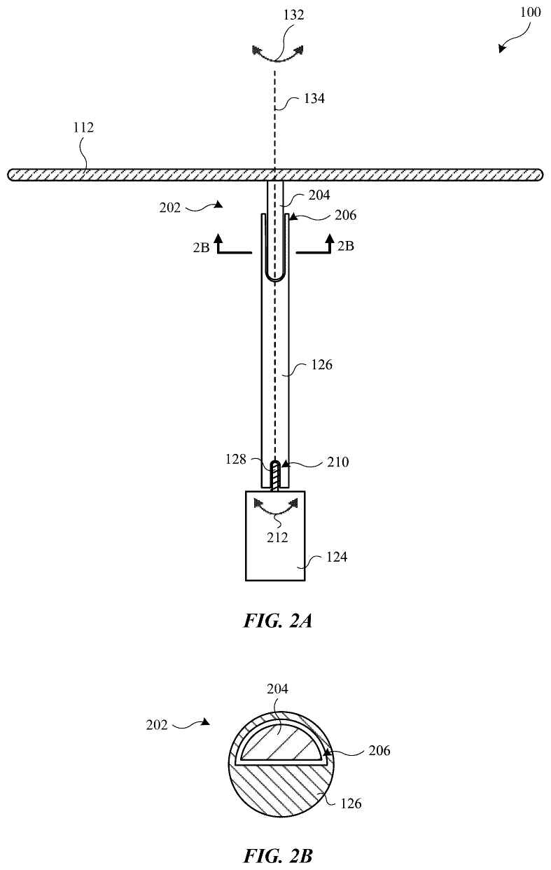

FIG. 2A illustrates a front view of a portion of the grill 100. In particular, FIG. 2A illustrates the grilling surface 112 connected to the motor 124. As discussed above, the grilling surface 112 may be coupled to the motor 124 via the rod 126, whereby the motor 124, the rod 126, and the grilling surface 112 may be coaxial along the axis of rotation 134 of the grilling surface 112.

The spindle 208 of the motor 124 may be configured to rotate in the direction 212 about the axis of rotation 134 of the grilling surface 112 to rotate the rod 126 and in turn rotate the grilling surface 112 about the axis of rotation 134. The spindle 128 may extend into a hole 210 defined by the rod 126 to couple the motor 124 to the rod 126. For example, the spindle 128 may be threaded and may be received by a hole 210 defined by the rod 126, whereby the hole 210 may include complementary threading therein. However, the spindle 128 may be connected to the rod 126 in any desired manner, such as via adhesives, other mechanical fasteners, the like, or a combination thereof.

The grilling surface 112 may also be coupled to the rod 126. For example, the rod 126 may be releasably coupled to the grilling surface 112 by a keying mechanism 202. The keying mechanism 202 may facilitate quick connection and quick release of the grilling surface 112 from the rod 126. For example, the keying mechanism 202 may allow for the grilling surface 112 to be quickly removed (e.g., disconnected) from the rod 126 so that the grilling surface 112 may be removed from the body 102 of the grill 100 for replacement and/or cleaning.

The keying mechanism 202 may include a male portion 204 coupled to the grilling surface 112. The male portion 204 may extend from or project from the grilling surface 112. For example, the male portion 204 may extend from a portion of the grilling surface 112 that supports the food items towards the rod 126. The male portion 204 may be integrally formed with the grilling surface 112 or may be coupled to the grilling surface 112 (e.g., welded and/or mechanically secured to the grilling surface 112).

The keying mechanism 202 may also include a female portion 206 defined by the rod 126 and configured to receive the male portion 204 to releasably couple the grilling surface 112 to the rod 126. The female portion 206 may be an opening and/or cavity of the rod 126. The female portion 206 may be located on an opposing end of the rod 126 compared to the hole 210 that receives the spindle 128 of the motor 124. For example, the hole 210 may be located on a first end of the rod 126 and the female portion 206 may be located on an opposing end of the rod 126 along a length of the rod 126 (e.g., as measured along the axis of rotation 134) such that the female portion 206 may be positioned closer to the grilling surface 112 and the male portion 204.

As shown in FIG. 2B, which illustrates cross-section 2B of FIG. 2A, the male portion 204 may be semi-circular in shape and the rod 126 may define female portion 206 that is also semi-circular in shape and is complimentary in shape to the male portion 204. As a result, the male portion 204 may extend into the female portion 206 in a manner that maintains a position of the grilling surface 112 with respect to the rod 126 during operation (e.g., rotation) of the grilling surface 112). For example, as shown in FIG. 2A, the male portion 204 may extend into the female portion 206 and may be supported by a base of the female portion 206 that is formed by the rod 126.

Additionally, due the semi-circular shape of the male portion 204 and the female portion 206, the keying mechanism 202 may prevent rotation of the grilling surface 112 with respect to the rod 126, or vice versa. That is, the keying mechanism 202 may act as an anti-rotation coupling between the male portion 204 and the female portion 206 so that the male portion 204 is unable to rotate independent of the female portion 206 and vice versa. However, it should be noted that the male portion 204 and the female portion 206 may be any shape and/or configuration to couple the grilling surface 112 to the rod 126 in a similar manner.

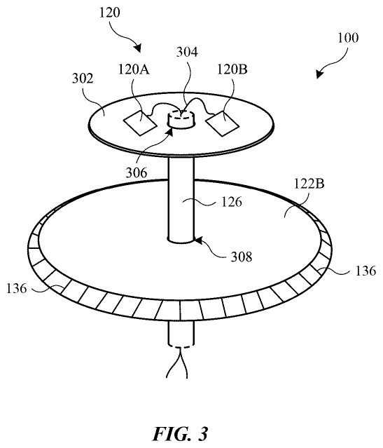

FIG. 3 illustrates a perspective view of the thermoelectric device 120 of the grill 100. As discussed above, the thermoelectric device 120 may be configured to convert heat energy (e.g., the heat 116 generated by the burner 114) into electrical energy to power the motor 124.

To facilitate such operation, the thermoelectric device 120 may include one or more thermoelectric generator portions, such as a first thermoelectric generator portion 120A and a second thermoelectric generator portion 120B, that may be configured to absorb or otherwise receive heat from a surrounding area (e.g., the interior cavity 102A of the body 102). The thermoelectric device 120 (e.g., the first thermoelectric generator portion 120A and the second thermoelectric generator portion 120B) may be disposed on a support plate 302. The support plate 302 may be any material that conducts heat. For example, the support plate 302 may be aluminum to transfer heat between the first thermoelectric generator portion 120A and the second thermoelectric generator portion 120B.

The support plate 302, and thus the thermoelectric device 120, may be positioned between the lower mounting plate 122B and the upper mounting plate 122A (not shown in FIG. 3 for clarity). As described above, the lower mounting plate 122B may include the one or more cooling fins 136. For example, the lower mounting plate 122B may be conical in shape such the cooling fins 136 my diverge in a direction away from the lower mounting plate 122B. It should also be noted that the upper mounting plate 122A and the lower mounting plate 122B may also be any desired material, such as aluminum.

As discussed above, the thermoelectric device 120 may power the motor 124 to rotate the grilling surface 112. To power the motor 124, the thermoelectric device 120 may be connected to the motor 124 via wiring 304 to transfer the electrical energy generated by the thermoelectric device 120 to the motor 124. The wiring 304 may be routed in any desired manner between the thermoelectric device 120 and the motor 124.

By way of example, the wiring 304 may be routed through the rod 126. The rod 126 may be hollow or define a channel therein. The wiring 304 may thus extend through the rod 126 between the thermoelectric device 120 and the motor 124. The rod 126 may extend through an opening 306 defined by the support plate 302 and an opening 308 defined by the lower mounting plate 122B such that the rod 126 may substantially extend between the thermoelectric device 120 and the motor 124. It should also be noted that only a portion of the 126 is shown in FIG. 3 and the rod 126 may also extend beyond the support plate 302, such as through the upper mounting plate 122A and into the interior cavity 102A of the body 102 to couple to the grilling surface 112. As such, the wiring 304 may extend through or adjacent to the rod 126.

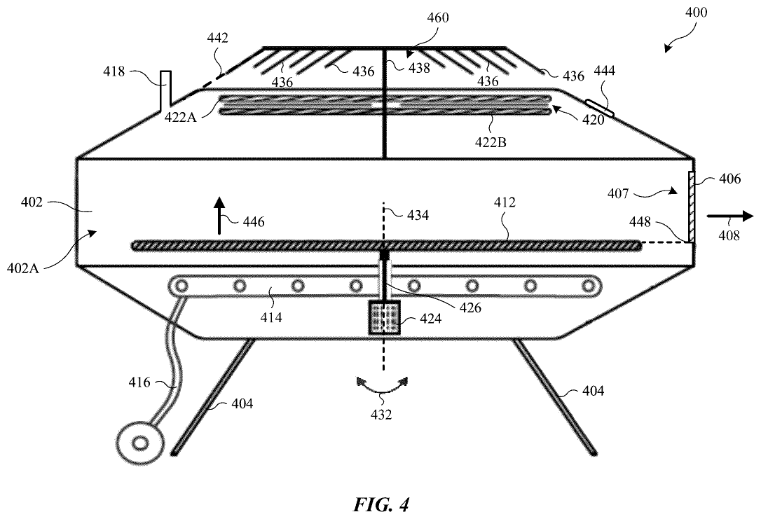

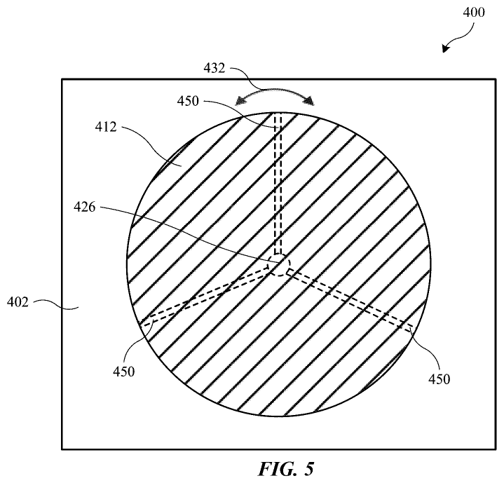

FIG. 4 illustrates a front view of an oven 400. The oven 400 may be similar to the grill 100 described above. That is, the oven 400 may include one or more components of the grill 100 that may operate in a similar manner unless otherwise described.

The oven 400 may include a body 402 defining an interior cavity 402A within the body 402. The interior cavity 402A may be similar to the interior cavity 102A described above such that the interior cavity 402A may be configured to at least partially contain one or more food items for cooking, whereby heat may be contained and regulated within the interior cavity 402A to cook the food items. The body 402 may include any desired shape and may be freestanding or supported by one or more support structures, such as legs 404.

Additionally, while the grill 100 described above may include the lid 106 to permit access to the interior cavity 102A, the oven 400 may include a door 406 which permits access to the interior cavity 402A of the body 402. That is, the door 406 may permit access through an opening 407 of the body 402. The door 406 may be movably coupled to the oven 400 to facilitate movement of the door 406 to expose the opening 407. For example, the door 406 may be slidably and/or pivotally engaged to the body 402 such that the door 406 may move in a direction 408 to expose the opening 407 and permit access to the interior cavity 402A. The door 406 may also be removed or otherwise disconnected from the body 402 altogether to expose the opening 407.

A cooking surface 412 may be located within the interior cavity 402A. The cooking surface 412 may be similar to the grilling surface 112 of the grill 100. The cooking surface 412 may define one or more openings therein (e.g., a grate) or may be a substantially continuous surface. For example, the cooking surface 412 may be a substantially continuous ceramic surface that may be configured to support larger food items, such as a pizza or bread. Thus, the cooking surface 412 is not particularly limited to any specific type of surface.

Additionally, to facilitate ease of placing items on the cooking surface 412, the cooking surface 412 may be aligned with a bottom 448 of the opening 407 with respect to an elevational direction of the oven 400, as illustrated by the dashed line in FIG. 4. For example, the cooking surface 412 may be aligned with the bottom 448 of the opening 407 to easily slide a pizza on and off of the cooking surface 412 through the opening 407 (e.g., using a peel) without damaging and/or dropping the pizza.

The oven 400 may also include a burner 414 disposed within the interior cavity 402A and positioned adjacent or otherwise near the cooking surface 412. The burner 414 may also be placed anywhere to facilitate heat generated by the burner 414 increasing a temperature within the interior cavity 402A. The burner 414 may be connected to a gas source, such as propane or natural gas, via a hose 416 and may generate heat in a similar manner to the burner 114 described above.

Alternatively, the oven 400 may be free of the burner 414. For example, a lower region of the interior cavity 402A may be filled with charcoal and/or wood, which may be ignited to generate heat within the interior cavity 402A. As such, the oven 400 is not particularly limited to the burner 414, and a similar configuration may also be possible with the grill 100 described above. Moreover, heat within the interior cavity 402A may be monitored and/or controlled via a gauge 444 located external to the body 402 and/or coupled to the body 402.

The oven 400 may also include ventilation, such as a chimney 418 therein, the expel smoke and/or excess heat from within the interior cavity 402A. The chimney 418 may be positioned anywhere along the body 402. Alternatively, the body 402 may be free of any chimney 418.

Similar to the grill 100, the cooking surface 412 may be configured to rotate with respect to the body 402. The oven 400 may include a thermoelectric device 420, which may be similar to thermoelectric device 120 described above, to power rotation of the cooking surface 412. For example, the thermoelectric device 420 may be positioned between an upper mounting surface 422A and a lower mounting surface 422B, whereby the upper mounting surface 422A may be coupled to an interior surface of the interior cavity 402A to position the thermoelectric device 420 above the cooking surface 412 in the elevational direction of the oven 400.

To facilitate rotation of the cooking surface 412, the thermoelectric device 420 may be wired to a motor 424 of the oven 400. As such, the thermoelectric device 420 may be located within the interior cavity 402A and configured to power the motor 424 by converting the heat within the interior cavity 402A (e.g., the heat generated by the burner 414) into electrical energy (i.e., electricity), which may in turn be transferred to the motor 424 to power the motor 424. Such wiring between the motor 424 and the thermoelectric device 420 may be done in any desired manner.

Due to receiving power from the thermoelectric device 420, the motor 424 may be configured to rotate the cooking surface 412 in a direction 432 about an axis of rotation 434 of the cooking surface 412. For example, the motor 424 may be coupled to the cooking surface 412 via a rod 426 extending therebetween, whereby the motor 424 may rotate the rod 426 which in turn may rotate the cooking surface 412 about the axis of rotation 434. The motor 424, the rod 426, and the cooking surface 412 may be coaxial along the axis of rotation 434 to facilitate such rotation. Such rotation may also be controlled by the gauge 444. For example, the gauge 444 may include speed controls to adjust a rotational speed (i.e., RPM) of the cooking surface 412.

As shown in FIG. 4, the motor 424 may be located below the cooking surface 412 while the thermoelectric device 420 may be located above the cooking surface 412 with respect to the elevational direction of the oven 400. However, both the motor 424 and the thermoelectric device 420 may be located above or below the cooking surface 412 in different examples. Moreover, while the motor 424 and the thermoelectric device 420 are shown as being located within the interior cavity 402A, the motor 424 and/or the thermoelectric device 420 may be located external to the interior cavity 402A (e.g., external to the body 402).

The cooking surface 412 may also be removably coupled to the rod 426 to facilitate removal of the cooking surface 412 from the oven 400 for cleaning and/or replacement. For example, the cooking surface 412 may be coupled to the rod 426 via a keying mechanism similar to the keying mechanism 202 of the grill 100 shown in FIGS. 2A and 2B. As such, the cooking surface 412 may be disconnected from the rod 426 in a direction 446 such that the cooking surface 412 may be removed from the interior cavity 402A through the opening 407 of the body 402. Similarly, such easy disconnection of the cooking surface 412 may allow for interchangeability between cooking surfaces. For example, the cooking surface 412 may be interchanged with other sizes of the cooking surface 412 and/or other cooking surfaces that may be different materials and/or configurations, thereby providing additional customization to the oven 400.

The oven 400 may also include one or more cooling mechanisms to regulate and/or cool a region of the oven 400 or a region surrounding the oven 400. For example, the oven 400 may include one or more cooling fins 436 located external to the oven 400 and coupled to the oven 400 via a mounting bracket 438. The mounting bracket 438 may extend to or into the oven 400 to secure the cooling fins 436 in a desired position. For example, the cooling fins 436 may be located adjacent to and external of the thermoelectric device 420, whereby an airspace 440 may be located between the cooling fins 436 and the thermoelectric device 420 and/or the body 402. The cooling fins 436 may also be tapered or include a tapered surface 442 that may align with a surface of the body 402. As a result, the cooling fins 436 may be configured to deflect or otherwise route water (e.g., debris) or debris away from a central portion of the oven 400.

FIG. 5 illustrates an example of the cooking surface 412 of the oven 400. In particular, FIG. 5 illustrates a top-down view of a portion of the oven 400 shown in FIG. 4. As discussed above, the cooking surface 412 may be configured to rotate in the direction 432 about the axis of rotation 434 of the cooking surface 412. The rod 426 may be coupled to the motor 424 and may be coupled to the cooking surface 412 to facilitate rotation of the cooking surface 412 in the direction 432. During rotation of the cooking surface 412, the cooking surface 412 may remain within the interior cavity 402A and the body 402 of the oven 400 may remain stationary.

To promote air circulation within the interior cavity 402A, the oven 400 may also include one or more circulation fins 450. The circulation fins 450 may be coupled to the rod 426 and/or the cooking surface 412 such that rotation of the cooking surface 412 and/or the rod 426 in the direction 432 may also rotate the circulating fins 450. For example, the circulation fins 450 may be coupled to a bottom portion of the cooking surface 412. During rotation, the circulation fins 450 may circulate the air through the cooking surface 412 and throughout the interior cavity 402A, thereby promoting more even cooking of one or more food items located on the cooking surface 412. To facilitate such air circulation, the circulation fins 450 may be positioned or otherwise oriented in any desired direction and/or angle with respect to the cooking surface 412. Similarly, the circulation fins 450 are not particularly limited to any one structure and may vary in size and/or shape. For example, the circulation fins 450 may define one or more opening therein and/or include one or more bends therein.

It should be noted that above circulation fins 450 may also be incorporated into the grill 100 as described above. The circulation fins 450 may be incorporated into a similar manner as shown in FIG. 5. For example, the circulation fins 450 may be coupled to, or otherwise integrated with, the grilling surface 112 such that rotation of the grilling surface 112 may also rotate the circulation fins 450 to circulate air within the interior cavity 102A. Moreover, the circulation fins 450 integrated into the grill 100 described above may have a different positioning, size, shape, or a combination therefor to better fit within the interior cavity 102A, though such changes may not be needed.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A grill comprising:
a body defining an interior cavity;
a grilling surface disposed in the interior cavity; and
a motor coupled to the grilling surface and configured to rotate the grilling surface with respect to the body such that the grilling surface remains within the interior cavity of the body during rotation.

2. The grill of claim 1, wherein the motor is positioned external to the body and coupled to the grilling surface by a rod extending therebetween.

3. The grill of claim 2, wherein the rod defines an axis of rotation of the grilling surface.

4. The grill of claim 3, wherein the motor includes:
a spindle configured to rotate about the axis of rotation of the grilling surface, wherein the spindle is configured to couple to the rod.

5. The grill of claim 2, wherein the rod is releasably coupled to the grilling surface by a keying mechanism.

6. The grill of claim 5, wherein the keying mechanism includes:
a male portion coupled to the grilling surface; and
a female portion defined by the rod and configured to receive the male portion to releasably couple the grilling surface to the rod.

7. The grill of claim 1, wherein the grilling surface is circular in shape.

8. The grill of claim 1, further comprising:
a burner disposed in the interior cavity of the body and positioned adjacent to the grilling surface; and
a thermoelectric device that is configured to convert heat energy expelled by the burner into electrical energy to power the motor.

9. The grill of claim 8, wherein the thermoelectric device is located external to the body and coupled to an exterior portion of the body.

10. The grill of claim 8, wherein the thermoelectric device is located within the interior cavity of the body.

11. The grill of claim 8, wherein the thermoelectric device is located between an upper mounting plate and a lower mounting plate; and
wherein one or more cooling fins are coupled to, and extend from, the lower mounting plate.

12. The grill of claim 11, wherein the motor is located between the one or more cooling fins.

13. A grill comprising:
a body defining an interior cavity;
a grilling surface disposed in the interior cavity and configured to rotate about an axis of rotation;
a burner configured to generate heat within the interior cavity of the body;
a motor;
a rod coupled to the motor and coupled to the grilling surface, wherein the motor is configured to rotate the rod such that the rod in turn rotates the grilling surface about the axis of rotation; and
a thermoelectric device configured to power the motor based upon conversion of the heat generated by the burner into electrical energy.

14. The grill of claim 13, wherein the thermoelectric device is connected to the motor via wiring to transfer the electrical energy to the motor.

15. The grill of claim 13, wherein the thermoelectric device is located external to the body.

16. The grill of claim 13, wherein the thermoelectric device is disposed on a support plate; and
wherein the support plate is located between an upper mounting plate and a lower mounting plate.

17. The grill of claim 13, wherein the grilling surface, the rod, and the motor are coaxial along the axis of rotation of the grilling surface.

18. An oven, comprising:
a body defining an interior cavity and that includes a door which permits access to the interior cavity;
a cooking surface located within the interior cavity;
a motor coupled to the cooking surface and configured to rotate the cooking surface about an axis of rotation; and
a thermoelectric device located within the interior cavity and that is configured to power the motor.

19. The oven of claim 18, wherein the thermoelectric device is located above the cooking surface in an elevational direction of the oven.

20. The oven of claim 19, wherein the door permits access through an opening of the body and the cooking surface is aligned with a bottom of the opening with respect to the elevational direction.
